(19) United States
(12) Patent Application Publication
(10) Pub. No.: US 2017/0241876 A1
(43) Pub. Date: Aug. 24, 2017

(54) INDUCTIVE MELTING OF PARAFFIN BY MEANS OF METALLIC BODIES CONTAINED THEREIN

(71) Applicant: LEICA BIOSYSTEMS NUSSLOCH GMBH, Nussloch (DE)

(72) Inventors: Hermann ULBRICH, Bad Schonborn-Mingolsheim (DE); Simon KEIMER, Leimen (DE)

(21) Appl. No.: 15/435,479

(22) Filed: Feb. 17, 2017

(30) Foreign Application Priority Data
Feb. 18, 2016 (DE) 10 2016 202 507.4

(51) Int. Cl. G01N 1/36; C08L 91/06; G01N 1/44

(52) U.S. Cl. CPC G01N 1/36; G01N 1/44; C08L 91/06

(57) ABSTRACT

The present invention relates to a method for melting paraffin, the paraffin (1) that is to be melted, and metallic bodies (2), being arranged in a melting container (210), eddy currents being induced in the metallic bodies (2) using at least one inductor (220); furthermore to a melting apparatus (200) for melting paraffin, having a melting container (210) for receiving paraffin (1) that is to be melted and metallic bodies (2), and having an inductor (220) for inducing eddy currents in the metallic bodies (2) received in the melting container (210); and to paraffin (1), having metallic bodies (2) embedded therein, which is configured in order to be inductively melted in a melting container (210).

### CROSS REFERENCE TO RELATED APPLICATIONS

This application claims priority of German patent application number 10 2016 202 507.4 filed Feb. 18, 2016, the entire disclosure of which is incorporated by reference herein.

### FIELD OF THE INVENTION

The present invention relates to a method and an apparatus for melting paraffin, and to a laboratory device having such an apparatus.

### BACKGROUND OF THE INVENTION

US 2006/0 219 712 A1 discloses a warming element that is heated in a microwave oven. The warming element comprises metallic bodies that are heated in the microwave oven by eddy currents.

DE 102 23 304 A1 discloses an apparatus for embedding samples in paraffin, having a pouring station and a reservoir container for the paraffin. The reservoir container is equipped with a heating device for melting paraffin in solid form. Here all of the paraffin is melted, and is stored in a molten state during operation.

DE 10 2008 054 071 A1 describes a tissue processor for processing tissue samples. The processor comprises, besides several chemical tanks, containers for liquid paraffin as well as a reservoir station for melting paraffin pellets or paraffin flakes. Molten paraffin can be pumped via conduits from the reservoir station into the containers.

WO 2006/089365 A1 discloses a tissue processor having a reservoir container whose floor is equipped with a heating element, for melting paraffin blocks. The paraffin blocks can be stacked on one another, at first only the lower block being melted. Contact between the lower paraffin block and the heated floor is ensured by a weight on the paraffin blocks. A heating mandrel projecting into the melting container is furthermore provided as an additional heating element.

The known melting apparatuses are disadvantageous in that melting takes a relatively long time, and in the meantime it is not possible to withdraw liquid paraffin. Proceeding from this existing art, the intention is to shorten the melting time.

### DISCLOSURE OF THE INVENTION

The present invention proposes a method and an apparatus for melting paraffin as well as a laboratory device having such an apparatus, having the features of the independent claims. Paraffin having metallic bodies embedded therein, which paraffin is configured in order to be melted, is also a subject of the invention. Advantageous embodiments are the subject matter of the dependent claims and of the description that follows.

The invention is based on the feature of arranging paraffin and metallic bodies in a melting container, and then inductively heating the metallic bodies and optionally also a metallic container wall. Thanks to the distribution of the metallic bodies in the paraffin that is to be melted, the latter is heated not only from outside as in the case of conventional melting methods, but also in its bulk, with the result that it melts appreciably more quickly. With the approach according to the present invention, required quantities of paraffin can quickly be melted in controlled fashion. Removal of the metallic bodies from the molten paraffin can be achieved very easily using suitable separation apparatuses, in particular using sieves, or by magnetic removal in the context of preferred ferromagnetic bodies.

The invention can be used particularly advantageously in laboratory devices, such as tissue processors (cf. WO 2006/089365 A1, DE 10 2008 054 071 A1, WO 2005/116609 A1) or automatic embedding machines (cf. DE 102 23 304 A1, DE 10 2007 022 014 A1).

According to the present invention the metallic bodies encompass particles and/or spheres and/or grid strips.

The metallic bodies preferably encompass ferromagnetic bodies, e.g. comprising iron, cobalt, nickel, and/or rare earths, and/or have a volume of less than 5 mm³, in particular of 2 to 3 mm³. The metallic bodies are preferably made of a non-corroding metal or have a coating made of a non-corroding metal.

The metallic bodies preferably encompass metallic bodies embedded in the paraffin that is to be melted. This allows very simple provision of completely prepared paraffin, which needs only to be poured into the container. Alternatively or additionally, the metallic bodies can also be poured into the melting container together with the paraffin, which in this case is present in fragmented form, for example in blocks, pieces, beads, pellets, flakes, etc. Here the metallic bodies can preferably be reused, which makes this alternative very inexpensive.

According to a further preferred embodiment, the metallic bodies encompass metallic bodies mounted or inserted in the melting container, e.g. inserted, suspended, and/or skewered spheres and/or an inserted or mounted grid or the like. The volume of mounted or inserted metallic bodies is usefully greater than the volume of loose metallic bodies or ones embedded in the paraffin that is to be melted. Provision can be made that the mounted bodies are mounted in the melting container detachably, for example for cleaning purposes. In this case as well, the paraffin that is to be melted is preferably present in fragmented form so that it can very easily be poured into the container having the metallic bodies. Here as well, the metallic bodies can be reused, which makes this alternative very inexpensive.

Further advantages and embodiments of the invention are evident from the description and the appended drawings.

It is understood that the features recited above and those yet to be explained below are usable not only in the respective combination indicated, but also in other combinations or in isolation, without departing from the scope of the present invention.

The invention is schematically depicted in the drawings on the basis of an exemplifying embodiment, and will be described in detail below with reference to the drawings.

### BRIEF DESCRIPTION OF THE DRAWING VIEWS

FIG. 1 very schematically shows an embodiment in principle of a melting apparatus according to the present invention.

FIG. 2 very schematically shows a further preferred embodiment of a melting apparatus according to the present invention.

FIG. 3 very schematically shows a further preferred embodiment of a melting apparatus according to the present invention.

### DETAILED DESCRIPTION OF THE INVENTION

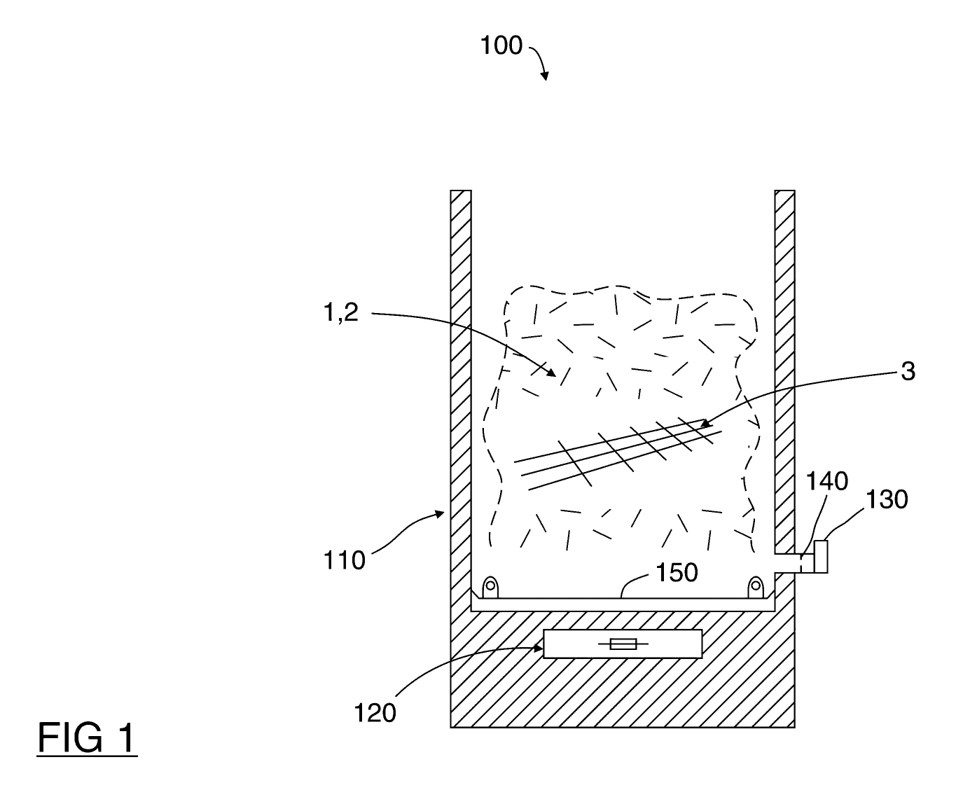

FIG. 1 very schematically shows an embodiment of a melting apparatus according to the present invention, which is labeled 100 in its entirety.

Melting apparatus 100 comprises a melting container 110 in which paraffin 1 that is to be melted is arranged. The paraffin can be introduced or poured into melting container 110, for example, in the form of blocks or plates, pieces, beads, pellets, flakes, etc.

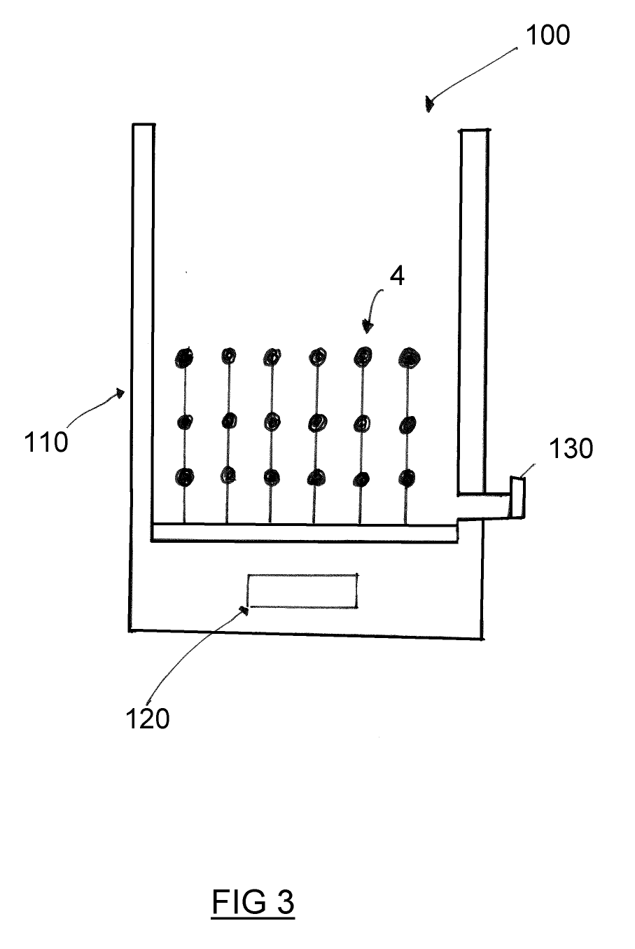

Metallic bodies 2, 3 are arranged in melting container 110 together with paraffin 1 that is to be melted. The metallic bodies in particular can be embedded as metallic particles 2 in paraffin 1 that is to be melted, and/or they can be mounted in melting container 110, for example in the form of a grid 3 or an arrangement 4 of lined-up or skewered spheres (FIG. 3), or the like.

In order to induce eddy currents in metallic bodies 2, 3, 4, melting apparatus 100 comprises at least one inductor 120 that can be embodied in particular in the form of a flat induction coil. Inductor 120 is arranged below a floor of melting container 110.

For withdrawal or release of the molten paraffin, melting apparatus 100 comprises an opening having a valve 130. For removal of the metallic bodies from the molten paraffin, a particle filter or sieve 140 is arranged as a separation apparatus in front of valve 130. In an embodiment with no loose particles, for example in accordance with FIG. 3, sieve 140 can also be omitted.

A detachable sieve 150 can be provided as a further separation apparatus for the withdrawal of metallic bodies 2 from melting container 110. In an embodiment with no loose particles, for example in accordance with FIG. 3, sieve 150 can also be omitted.

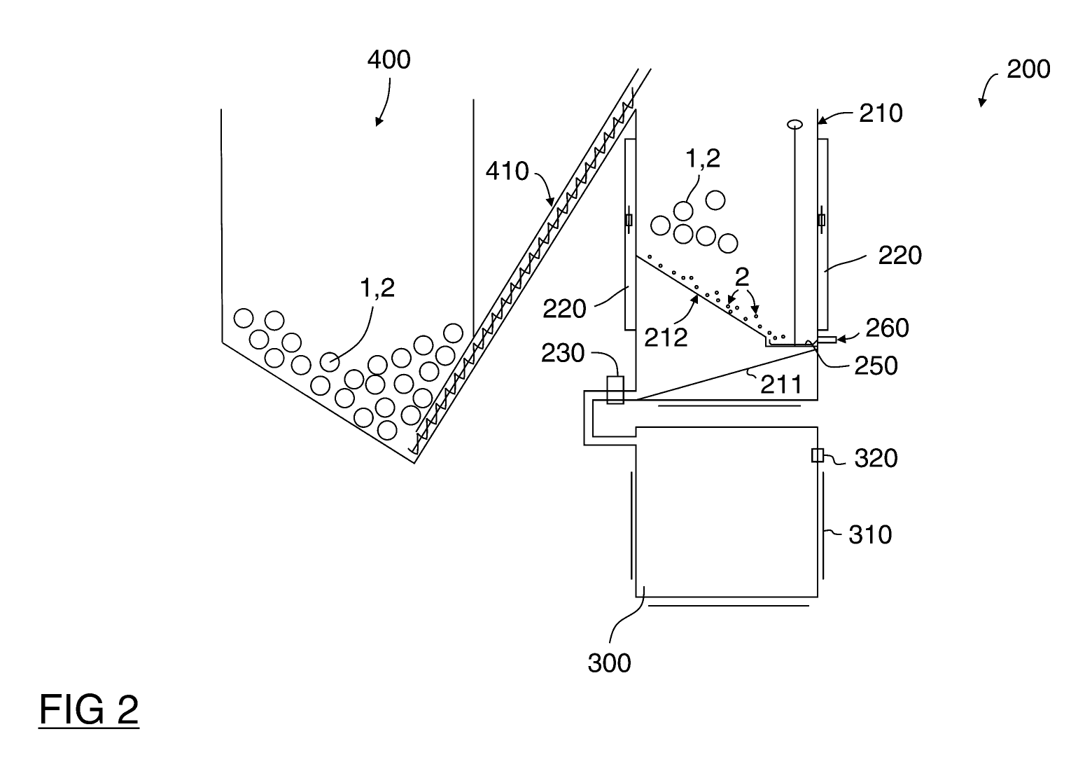

FIG. 2 very schematically depicts a further preferred embodiment of a melting apparatus 200 according to the present invention. Melting apparatus 200 comprises a melting container 210 in which paraffin 1 that is to be melted, and metallic bodies 2, are arranged. Melting apparatus 200 furthermore comprises inductors, embodied as coil windings 220, which are arranged behind a side wall of melting container 210. The coil windings can be guided, for example, around melting container 210 as a cylindrical coil, or can be arranged as flat coils next to, for example, planar side walls.

In the illustration depicted, melting container 210 comprises an oblique floor 211 that is tilted toward an outflow or outlet having a valve 230. This configuration serves to allow very easy withdrawal of the molten paraffin from melting container 210 by opening a valve 230.

Arranged downstream from the valve is a storage container 300 for molten paraffin, which is also heated, for example by means of conventional resistance heating elements 310. A fill level sensor 320 of storage container 300 serves to detect the fill level of the molten paraffin and, for example, can interact with valve 230 in such a way that valve 230 opens as soon as the fill level of the molten paraffin in storage container 300 reaches or falls below a predefinable lower threshold value, and/or closes as soon as the fill level of the molten paraffin in storage container 300 reaches or exceeds a predefinable upper threshold value.

Melting container 210 comprises a separation apparatus embodied as a detachable sieve 250, so that loose metallic particles 2 can be withdrawn from melting container 210. An oblique intermediate floor 211 serves to guide the loose metallic bodies 2 into separation apparatus 250, which can have a trough shape for collection of the loose metallic bodies. Intermediate floor 211 can be permeable to the paraffin.

A sensor 260 for determining the quantity of loose metallic bodies 2 can be provided in order to ensure timely withdrawal of the metallic bodies.

Melting apparatus 200 furthermore comprises a reservoir container 400 for paraffin 1 that is to be melted and has embedded metallic bodies 2, from which container paraffin 1 that is to be melted and has embedded metallic bodies 2 can be conveyed via a feeder, e.g. a screw conveyor system 410, into melting container 210.

Metallic bodies 2 are embodied in FIGS. 1 and 2, for example, as (in particular, ferromagnetic) particles that are embedded into the fragmented, in particular spherical or substantially spherical, paraffin. The size of metallic particles 2 is preferably in a range from 2 to 3 mm³.

Ferromagnetic metallic bodies can be heated more easily by induction than non-ferromagnetic ones, and in particular can also be collected and disposed of, after melting, using a magnet.

Alternative or additionally, as in FIGS. 1 and 3, metallic bodies 3, 4 can be embodied as (in particular, ferromagnetic) structures that are mounted in the melting container or inserted or placed thereinto.

What is claimed is:

1. A method for melting paraffin, the paraffin (1) that is to be melted, and metallic bodies (2, 3), being arranged in a melting container (110, 210), eddy currents being induced in the metallic bodies (2, 3) using at least one inductor (120, 220),
the metallic bodies (2, 3) comprising particles and/or spheres and/or grid strips.

2. The method according to claim 1, the metallic bodies (2, 3) comprising metallic bodies embedded in the paraffin (1) that is to be melted.

3. The method according to claim 1, the metallic bodies (2, 3) comprising metallic bodies poured into the melting container (110) together with the paraffin.

4. The method according to claim 1, the metallic bodies (2, 3) comprising metallic bodies mounted in the melting container (110).

5. The method according to claim 1, the metallic bodies (2, 3) comprising ferromagnetic bodies.

6. The method according to claim 5, the metallic bodies (2, 3) being withdrawn from the molten paraffin, after melting, by means of magnetic force.

7. The method according to claim 1, the metallic bodies (2, 3) being removed from the molten paraffin, after melting, by means of a separation apparatus (140, 150, 250).

8. The method according claim 1, the molten paraffin being withdrawn from the melting container (110, 210) via a valve (130, 230).

9. A melting apparatus (100, 200) for melting paraffin, having a melting container (110, 210) for receiving paraffin (1) that is to be melted and metallic bodies (2, 3), and having an inductor (120, 220) for inducing eddy currents in the metallic bodies (2, 3) received in the melting container (110, 210),
the melting container (110, 210) comprising a floor and at least one side wall, and the inductor comprising at least one induction coil winding under the floor and/or behind the side wall of the melting container (110, 210).

10. The melting apparatus (100, 200) according to claim 9, having means for melting paraffin by inducing eddy currents in metallic bodies (2, 3) present in a container with the paraffin (1) that is to be melted, the metallic bodies (2, 3) comprising particles and/or spheres and/or grid strips.

11. A laboratory device having a melting apparatus (100, 200) according to claim 9.

12. Paraffin (1), having metallic bodies (2) embedded therein, configured to be inductively melted in a melting container (110, 210).

13. The paraffin (1) according to claim 12, the embedded metallic bodies (2) comprising ferromagnetic bodies.

14. The paraffin (1) according to claim 12, the embedded metallic bodies (2) comprising particles and/or spheres.

15. The paraffin (1) according to claim 12, the embedded metallic bodies (2) comprising bodies having a volume from 2 to 3 mm³.

16. The paraffin (1) according to claim 12, the embedded metallic bodies (2) being made of a non-corroding metal or comprising a coating made of a non-corroding metal.
